(19) United States
(12) Patent Application Publication
(10) Pub. No.: US 2006/0158958 A1
(43) Pub. Date: Jul. 20, 2006

(54) Beverage Container With Integrated Mixing Device

(76) Inventor: Philip Romanik, West Haven, CT (US)

Correspondence Address: Philip Romanik, 116 Parker Avenue East, West Haven, CT, 06516, US

(21) Appl. No.: 10/905,673

(22) Filed: Jan. 15, 2005

(51) Int. Cl. A47J 43/046

(52) U.S. Cl. 366/205; 366/314

(57) ABSTRACT

A portable beverage container with an integrated mixing device to homogenize its contents. The container includes a mixing element which can be connected to an external mixing base or operated via a manually operated crank or stick. The mixing element can require a minimum breaking force to prevent premature mixing of the contents. This breaking element can also incorporate a liquid impervious storage area to keep some ingredients separate from the fluid prior to mixing.

### BACKGROUND OF THE INVENTION

Beverage containers of numerous sizes, shapes, and materials have been used for years to hold drinks such as juice, water, or soda. Personal-sized containers, typically those that are 20 ounces or less, are very popular and are sold in both single-unit and multiple-unit quantities. Once opened, these containers are held in the hand and are also drunk from directly. When finished, these containers are usually discarded or recycled.

Homogeneous drinks such as soda or water are very stable while stored in these containers and are ready to drink when opened. The consumer's main requirement for these drinks is the temperature of the liquid, or the ability to close, or cap, the container. Heterogeneous drinks on the other hand are usually mixed before drinking. Fruit juice is a good example of a heterogeneous drink since they tend to settle during storage. Juices can usually be returned to a more uniform consistency with either small or moderate shaking. This shaking can increase the chances of injury to people, or prove difficult for people with physical impairment of the hands, such as arthritis.

Another problem with a conventional beverage container is that some liquids do not work very well when packaged and sold in already-mixed containers. Shaking alone is not sufficient to mix all the ingredients. For example, milkshakes and many protein supplement drinks are often mixed in a blender before consumption to completely mix the ingredients.

Further, these mixing difficulties limit the popularity of many drink mixtures. Drinks which must be prepared manually with a blender are limited by the number of drinks that can be prepared per unit of time. Cross-contamination and sanitation concerns also create the need to clean the equipment between uses. Manually-mixed drinks are rarely served in reseal-able containers, further limiting their portability.

Accordingly, one objective of the present invention is to provide a portable container with built-in mixing capabilities via blades, vanes, or other mixing elements. This container can be of the single-use or multiple-use variety. The single-use configuration can be dispensed from a conventional beverage machine, and is intended to be disposable.

Another objective of the present invention is to de-couple the device which delivers the energy to drive the mixing elements from the beverage container itself. This allows the beverage container to use either a manually operated, and possibly disposable, hand device, or a stationary mixing base to mix the contents of the container.

Yet another object of the present invention is the provision for modifying a beverage machine to mix the contents of the beverage container before it is dispensed.

Another objective of the present invention is to provide a plurality of methods by which the mixing base is coupled to the mixing elements inside the beverage container.

### BRIEF SUMMARY OF THE INVENTION

The beverage container of the present invention includes built-in mixing elements allowing the contents to be completely mixed without having to be removed from the container. In one aspect of the invention, the container can be single-use or multiple-use, but in the preferred embodiment is disposable or recyclable. The container can contain a variety of constituents, including both liquid and solid ingredients which must be homogenized or mixed prior to consumption. This mixing action can be used to thicken and increase the viscosity of the contents. This mixing action can also be used to introduce air into the mixture. The user can also add additional ingredients if the top of the beverage container is open.

In another aspect of the invention, the mixing elements inside the beverage container are de-coupled from the mixing unit itself. This allows the beverage container to be portable, and self-contained. The connection between the beverage container and mixing unit can be physical, magnetic, or some other means. In the preferred embodiment, the connection is physical using a multiple-hole configuration on the bottom of the beverage container to connect the mixing unit with the mixing element. One hole is located in the center of the beverage container bottom, while one or more other holes are located towards the outside of the container bottom. The physical coupling can also use a gear-like element to provide the power to turn the mixing element. A magnetic coupling, or other means, can also provide the ability to mix the beverage container without any physical interlocking of the beverage container and mixing unit.

In yet another aspect of the invention, the mixing elements inside the beverage container are chosen depending upon what must be mixed or blended. A number of considerations must be taken into account in designing the mixing element,
Beverage container geometry.
Fill level and consistency of the liquid, and possibly solid, contents.
Agitator design, including size and position of the agitator elements.
Mixing speed and mixing time.

Although the mixing element is application dependent, in the preferred embodiment the element is a flat plastic disk with raised impellers to generate the necessary agitation is used. A gear-like paddle can also be employed to generate an efficient mixing vortex. The storage of solid or other liquid ingredients can also be integrated into the mixing element to keep it separate from the liquid in the rest of the beverage container until they are mixed.

In another aspect of the invention, the mixing base can be both portable and of fixed design. Portable mixing bases include both manually powered cranks as well as battery powered motors. In the preferred embodiment for portable mixing bases, a simple, inexpensive, and disposable hand crank is used to provide the mixing power. It is designed for single-use and can provide a reasonable amount of mixing power. More sturdy hand-cranks can also be used which resemble an egg beater. Fixed, electric mixing bases are designed for multiple, long-term use. They provide a great deal more mixing power resulting in shorter mixing times. In the preferred embodiment for fixed mixing bases, the base is designed to quickly insert/remove a beverage container for mixing. A built-in timer and variable mixing speeds allows the mixing unit to adapt to the shape, size, and contents of the beverage container.

In still another aspect of the invention, the mixing base can be integrated into a beverage vending machine. When a beverage is selected, the container first is sent to a mixing station where the beverage container is coupled to a mixing base so the contents can be mixed at a preset speed and length of time. The beverage container is then dispensed to the customer for consumption.

In another aspect of the invention, the coupling device on the base of the beverage container can be integrated into the design of the container itself. In this case, the entire bottom of the beverage container can turn which adds a toy-like nature to the container. In the preferred embodiment of the invention, the coupling device is slightly offset into the bottom of the container, making it accessible mainly to the mixing base. A non-zero amount of torque is also required to make the coupling device turn initially. This prevents the contents of the container to be mixed accidentally or before the beverage container is purchased.

### BRIEF DESCRIPTION OF THE SEVERAL VIEWS OF THE DRAWING

In the accompanying drawings, there are shown embodiments of the invention wherein like reference numerals may be employed to designate like parts, if applicable, and wherein:

FIG. 1 is a front view of a beverage container with an integrated mixing element.

FIG. 2 shows cross-sectional views of the coupling mechanism between the beverage container and a mixing base.

FIG. 3 shows the seal apparatus to prevent fluid leakage from the container used in the preferred embodiment of the invention.

FIG. 4 show cross-sectional views of various mixing element styles, including the raised impellor version used in the preferred embodiment of the invention.

FIG. 5 shows a cross-sectional view of a disposable hand operated mixing device and its attachment to the beverage container.

FIG. 6 shows a block diagram depicting how a mixing station can be integrated with a beverage vending machine.

### DETAILED DESCRIPTION OF THE INVENTION

Those of ordinary skill in the art will realize that the following description of the present invention is illustrative only and not in any way limiting. Other embodiments of the invention will readily suggest themselves to such skilled persons having the benefit of this disclosure. The various features of the invention will now be described with respect to the figures, in which like parts are identified with the same reference characters.

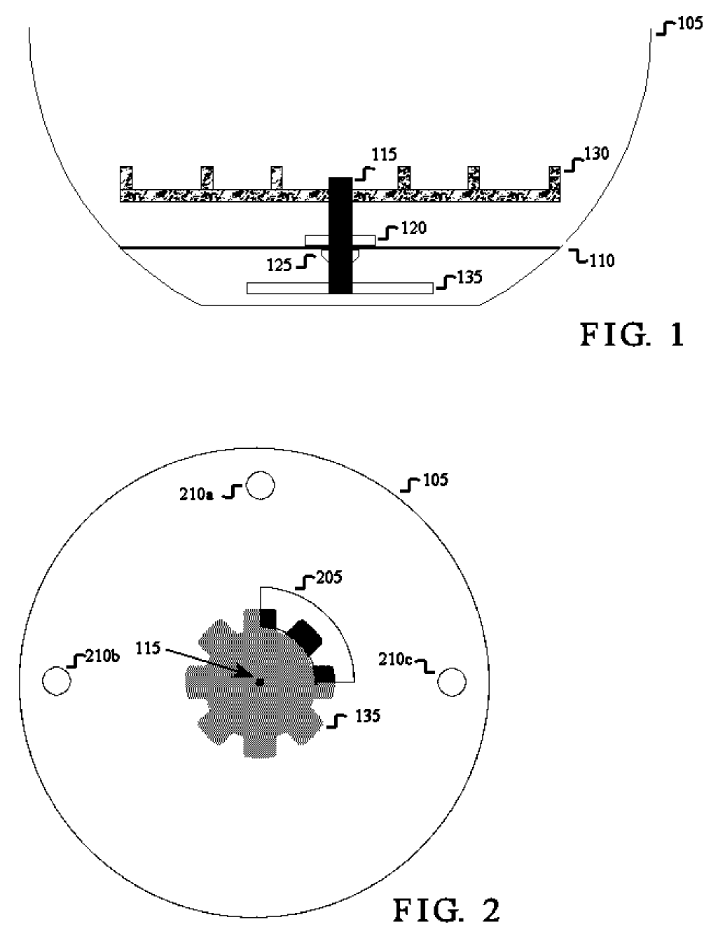

FIG. 1 is a view of the lower part of a beverage container according to the invention for a beverage container with an integrated mixing device. The beverage container, 105, has an internal bottom, 110, which forms the bottom of the container to enclose the beverage. This bottom is made from the same food-safe material as the sides of the container. Bottom 110 contains a hole through which spindle 115 is placed. This spindle transfers the energy imparted to the mixing gear 135 to the mixing blade 130. In the preferred embodiment of the invention, the spindle is fabricated with recyclable polypropylene. The diameter of spindle 115 is chosen based upon the torque applied to the mixing gear 135 and the viscosity and mixing requirements of the beverage in the container. To prevent leakage, spindle 115 passes through a seal constructed of an upper seal element 120 and a lower seal element 125. Although only the upper seal element must be fabricated from food-safe components, in the preferred embodiment, the entire seal is fabricated from the same recyclable polypropylene material. Mixing blade 130 will mix and evenly disburse the ingredients in the beverage container from the spinning motion delivered by spindle 115. The shape of mixing blade 130 is highly application dependent and depends upon the beverage viscosity and uniformity. In the preferred embodiment a flat, circular disc with raised mixing blades or vanes are employed to mix the contents of the container. As with the other components, the mixing blade is fabricated using food-safe components such as recyclable polypropylene. To prevent the mixing blade 130 from separating from spindle 115, the spindle is fused to the mixing blade in the preferred embodiment. Other methods include, but are not limited to, fabricating the spindle and mixing blade as a single unit, or molding a retainer and snap device to keep the mixing blade firmly attached to the spindle when pressed into place. A circular mixing gear 135 is attached to the spindle 115 and is used to transfer rotational energy from an external device to the mixing blade 130. In the preferred embodiment of the invention, the diameter of the mixing gear 135 depends on the viscosity of the beverage in the container as well as the hole or gear pattern used to interlock the beverage container with the external mixing base, with the diameter of the mixing gear 135 being about 50% of the diameter of the mixing blade 130.

A seal-like device can be mounted between mixing blade 130 and the container wall 105 or 110 for the purposes of restricting the motion of mixing blade 130. The seal prevents any premature mixing from occurring. In the preferred embodiment, a small piece of plastic prevents mixing blade 130 from turning until a sufficient breaking force is applied to mixing gear 135. Once broken, the seal will remain attached to mixing blade 130 and the container.

The seal-like device can also be used to house ingredients, such as, but not limited to, powders and other liquids, which are disbursed in the liquid once mixing begins. The housing is such that it is impervious to the liquid in the container, and the contents can only be extracted once sufficient breaking force is applied to mixing gear 135. In the preferred embodiment of the invention, a cylindrical enclosure is mounted on top of spindle 115. This enclosure contains one or more openings which are closed and attached to container wall 105 or 110. When sufficient breaking force is applied to mixing gear 135, the sealed container is torn open, disbursing its contents and mixing with the container liquid.

FIG. 2. is a view of the bottom of the beverage container 105. The mixing device apparatus is hidden by the perceived bottom of the beverage container. A small window in the bottom 205, exposes the elements to connect the mixing gear 135 to an external mixing base. If the mixing gear consists of a number of teeth as it does in the preferred embodiment, window 205 is annularly shaped, permitting a tooth or key in the external mixing base to cause the mixing blade 135 to rotate when a rotational force is applied. Another design for the mixing gear 135 can be, but not limited to, a flat circular disc with holes near the outside diameter of the gear. In this embodiment, part or the entire beverage container bottom turns when an external force is applied. The hole pattern is chosen to permit an easy connection between the beverage container and an external mixing base. The bottom contains fixture holes, e.g. holes 210a, 210b, 210c, referred to collectively as fixture holes 210, to help lock the beverage container to an external mixing base. By applying a downward force to the beverage container, either manually or by some fixturing device, pins in the external mixing base will keep the beverage container from turning while rotational energy is applied to mixing gear 135. These holes can be any shape or size but in the preferred embodiment of the invention, they are round and sized larger than the locking pins to make it easy for people, especially children, to place the container on the external mixing base. The mixing base itself can be any manually operated or powered unit which will deliver the necessary energy to turn the mixing gear 135. The mixing base contains fixture pins to make it easy to place the beverage container on the base. The container can be manually held in place or it can be held by the base itself. If the mixing gear 135 contains teeth, the mixing base contains similar teeth but vertically oriented whose rotation will cause mixing gear 135 to turn. The base can also include safety features to prevent it from operating unless a beverage container is firmly pressed against the unit, and is one means of automatically turning on the mixing base.

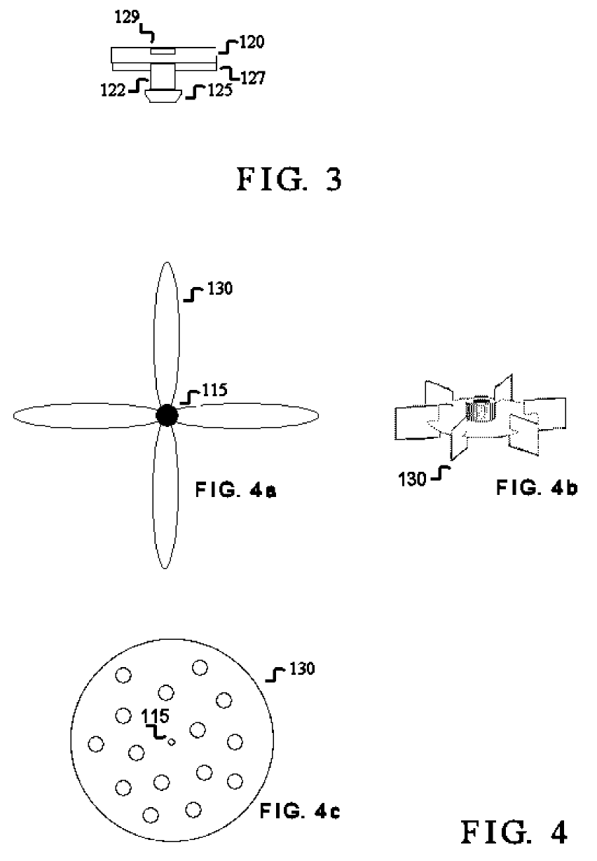

FIG. 3 shows the seal apparatus used in the preferred embodiment of the invention to prevent fluid leakage from the hole in the beverage container 105 which spindle 115 passes through. The seal contains an upper element 120 which resides inside the beverage container and a lower element 125 which resides below the container wall 110. In the preferred embodiment of the invention, the seal is pressed into a hole through the center of the beverage container 110. The size of the seal neck 122 is designed to be slightly larger than the thickness of the beverage container wall. A gasket or o-ring 127 is placed around the seal neck reducing the apparent size of the neck to be slightly smaller than the thickness of the beverage container wall. Gasket 127 can be made of a compressible material but in the preferred embodiment of the invention, it is fabricated from a thin piece of food grade polypropylene or low density polyethylene. The lower seal element 125 has a tapered head so it can be pressed into the hole in the inside bottom of the beverage container. Once installed, no fluid will be able to escape through the hole. A gasket or o-ring 129 is placed inside the upper seal element 120 to permit the spindle 115 to pass through without permitting any fluid loss. The diameter of spindle 120 is slightly smaller than the diameter through the seal neck 122 permitting the spindle to turn while the seal is locked in place. If the seal should turn slightly because of excessive torque applied to mixing gear 135, gasket 127 will prevent any fluid loss. Gasket 129 is placed in a recessed well in the upper seal element 120 and protrudes slightly. When the spindle is inserted into the seal element, a small molded ring on the spindle is pressed through the seal element and is held in place against the lower seal element 125. An upper molded ring of the spindle presses against the gasket 129 forming a tight seal. In another embodiment of the invention, no upper molded ring is necessary if the mixing blade 130 is designed to press firmly against the gasket 129. One benefit of this arrangement is that it requires a non-zero torque in order to turn the mixing gear 135. This prevents the mixing assembly from turning during transit or accidentally when purchased.

FIG. 4 demonstrates numerous configurations for mixing blade 130 which include but is not limited to these mixing elements. FIG. 4a shows a propeller-type design consisting of numerous blades which are bent upward to cause the fluid to mix when turned. These blades can be pitched if needed but doing so means there is a preferred direction of rotation to properly mix the beverage. FIG. 4b is a variation on the blade design, where fins are employed around a flat disc to create the mixing action. FIG. 4c depicts a flat disc with bumps or other protrusions to generate the mixing action. In this configuration it is expected that the velocity of the mixing element must be greater than other blade configuration in order to achieve the desired amount of mixing. However, this configuration can be easier to construct and is less prone to breakage. An example of still another variation of mixing blade is a whip design, where one or more small semi-rigid cord-like extensions are attached the mixing blade. These cords extend either a short distance or close to the entire length of the beverage container allowing for an adequate amount of mixing. The sound generated by these cords may also make a pleasant mechanical-like sound which adds to the enjoyment of mixing the beverage.

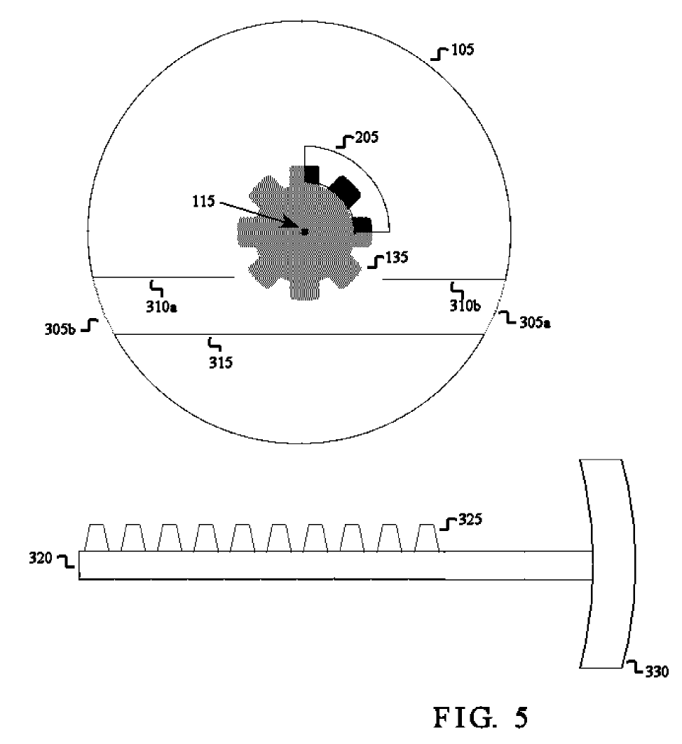

FIG. 5 shows an alternate beverage bottom design which permits both an external mixing base to generate the mixing energy as well as a hand-powered device to perform the same action. In this configuration, an opening 205, the same as shown in FIG. 2, is placed to permit attachment to an external mixing base. The fixture holes 210 from FIG. 2 are not shown. An upper groove, 310a and 310b, referred to collectively as groove 310 is molded in both the inside of the beverage container bottom and the internal bottom 110. This groove has a gap where the mixing gear 135 protrudes. A lower groove 315 is also molded into the base creating a channel of a fixed width. A slot, 305a and 305b, referred to collectively as slot 305, is also designed into the base, creating a passage way from one side of the container to the other, formed by upper grove 310 and lower grove 315. FIG. 5 also shows a manual mixer stick consisting of a handle 330, appendage 320 and numerous teeth 325. The width of appendage 320, including the height of teeth 325, is designed to be slightly smaller than the channel created by upper groove 310 and lower groove 315, permitting the mixing stick to be inserted easily into the slot 305. The teeth 325 will mesh with the mixing gear 135 allow the gear to turn when the mixing stick is push or pulled through slot 305. In the preferred embodiment of the invention, the mixing stick is manually pushed and pulled repeatedly into slot 305 to create the desired mixing action. It is also possible to vigorously pull the mixing stick once from the beverage container to generate the mixing action, although this may not completely mix the contents with a single attempt. Handle 330 is designed to fit securely in the hand and gripped in the palm of the hand with fingers wrapped around both sides of the handle. Handle 330 should be comfortable in both a child as well as an adult's hand and in the preferred embodiment of the invention is approximately 3 inches in width. The number of teeth 325 on the mixing stick is designed to permit one or more rotations of mixing gear 135 with a single pull or pushing action. The mixing stick can be constructed of any lightweight plastic material suitable for single-use or multiple-use applications. In the preferred embodiment of the invention the mixing stick is constructed from semi-rigid polyethylene, making it easy to store, transport and recycle.

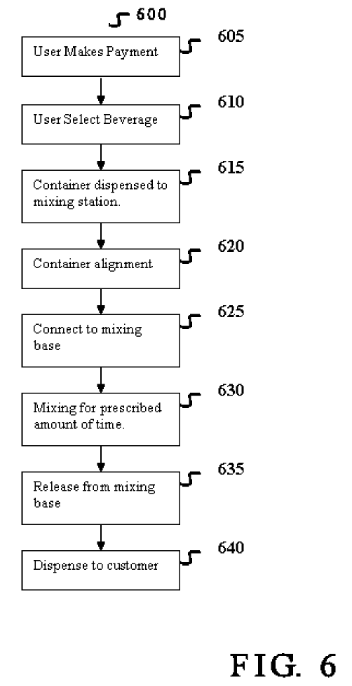

FIG. 6 is a flow chart illustrating a method 600 according to the invention of integrating the mixing device with an automatic vending machine. The process of automatically mixing a drink begins with step 605. In step 605, the user makes payment for the desired product. In step 610, the customer makes a selection for a product that requires mixing. In the preferred embodiment of the invention, the bottom of each beverage container looks like FIG. 2. The vending machine understands that the choice made in step 610 requires the product to be mixed. In step 615, the beverage container is dispensed to the mixing station. The mixing station can either be internal or external to the vending machine, but it is preferred that the user can see the mixing station and has the ability to extract the beverage container in case there is a problem during mixing. In step 620 the container is aligned so the dispensers mixing gear can align with the beverage containers gear 135. Alignment is most easily carried out by applying a downward force on the beverage container while rotating the container until the alignment holes 210 seats into the alignment pins of the mixing station. In step 625, the beverage container is held in place using a downward force such that the beverage container is in constant contact with the mixing station. In step 630, the mixing station begins turning a gear to transfer power to gear 135. When gear 135 is turned, impellor 130 turns to blend the drink. This blending step is continued for a fixed amount of time as programmed into the vending machine for each drink type. In step 635, the downward force is removed from the beverage container so that container will unseat from the mixing base. In step 640, the blended drink is delivered to the customer, either via a chute at the bottom of the vending machine, or by direct removal from the mixing station.

What is claimed is:

1. A filled fluid container comprising:
a. a container for containing a fluid;
b. a mixing element for blending various ingredients inside the container including, but not limited to, liquids, powders, and fruit;
c. An energy transfer mechanism located beneath the fluid compartment of the container to transfer an external force to move the mixing element.

2. A fluid container set forth in claim 1 wherein the mixing element achieves mixing by, but is not limited to, rotational movement of the mixing element to homogenize the contents of the container.

3. A fluid container set forth in claim 1 wherein the mixing element can take on the shape of, but is not limited to, an impellor, raised mixing bumps, or a cord-like whip.

4. A fluid container set forth in claim 1 wherein the mixing element can include a seal to prevent the mixing element from engaging until a sufficient external force is applied.

5. A fluid container set forth in claim 1 wherein the mixing element can include a liquid impervious storage area to prevent one of more ingredients from being mixed until a sufficient external force is applied.

6. A fluid container set forth in claim 5 wherein the stored ingredients include, but are not limited to, powders and liquids.

7. A fluid container set forth in claim 1 wherein the energy transfer mechanism can be accessed through a slot or window in the bottom of the container, or comprise the bottom portion of the container itself.

8. A fluid container set forth in claim 1 wherein the container can be attached to an external mixing station or blended manually using a mixing stick, to engage the energy transfer mechanism.

9. A mixing system comprising:
a. a fluid container with an integrated mixing element;
b. a mixing base with mounting apparatus to accept the fluid container in a specific orientation;
c. a means to transfer mechanical energy from the mixing base to the fluid container to affect mixing.

10. A system according to claim 9, wherein the mounting apparatus uses alignment pins to align the fluid container with the mixing base.

11. A system according to claim 9, wherein the mixing base uses gears to drive a mixing gear on the bottom of the fluid container which in turn drives the integrated mixing element.

12. A system according to claim 9, wherein the mixing base is incorporated into a vending machine with the steps;
a. transfer the fluid container to the mixing station;
b. orient the fluid container with the mixing station mounting apparatus;
c. attach the fluid container with the mixing station via the mixing gears;
d. mix the contents of the fluid container at a prescribed speed and length of time;
e. disengage the fluid container from the mixing station;
f. dispense the fluid container to the consumer.
